(19) United States
(12) Patent Application Publication
(10) Pub. No.: US 2007/0234657 A1
(43) Pub. Date: Oct. 11, 2007

(54) COMBINATION SEALING SYSTEM FOR SLIDING DOOR/WINDOW

(75) Inventors: William Kip Speyer, Boca Raton, FL (US); Jonathan D. Thielmann, Delray Beach, FL (US); Daniel P. Mammolito, Boynton Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: SPEYER DOOR AND WINDOW, INC., Boca Raton, FL (US)

(21) Appl. No.: 11/756,963

(22) Filed: Jun. 1, 2007

Related U.S. Application Data
(63) Continuation-in-part of application No. 11/322,952, filed on Dec. 30, 2005.

(51) Int. Cl. E06B 1/04

(52) U.S. Cl. 52/207

(57) ABSTRACT

A combined sealing system for connecting a panel to a frame includes a first sealing system and a second sealing system. The first sealing system connects a first surface of the panel to a first surface of the frame, and the first sealing system has a first movable member movable along a first direction. The second sealing system connects a second surface of the panel to a second surface of the frame, and the second sealing system has a second movable member movable along a second direction. The combined sealing system has an unlocked configuration and a locked configuration. In the unlocked configuration, the panel is movable relative to the frame along a third direction. The first and second directions not parallel to the third direction.

### CROSS-REFERENCE TO RELATED APPLICATIONS

This application is a Continuation-In-Part of U.S. application Ser. No. 11/322,952, filed on Dec. 30, 2005, incorporated herein by reference in its entirety.

### BACKGROUND OF THE INVENTION

1. Field of the Invention

The disclosure relates generally to sealing systems for use with panels, such as a door or a window, within a frame and, more specifically, to a sealing system for providing an improved seal between meeting stiles of adjacent panels and between a panel and frame.

2. Description of the Related Art

Certain types of panels, such as doors and windows, are positioned within openings of a wall and/or other structures using a frame. These panels may also open and close by sliding back and forth within the frame. An issue associated with these types of panels is the integrity of the seals between the panels and the frame and between adjacent meeting stiles of a pair of panels. In many instances, these seals are an insufficient barrier in preventing the transfer of such environmental elements as noise, weather, water, and insects from one side of the panel to the other side of the panel.

Examples of conventional connections between the meeting stiles of a pair of panels and between a frame and a panel are respectively illustrated in FIGS. 1A and 1B. In FIG. 1A, a first panel 10A and a second panel 10B each include a bottom rail 25 and a glass panel 32. Also, the first panel 10A includes a first meeting stile 20A that engages a second meeting stile 20B of the second panel 10B at interlocking extensions 22A, 22B of the first and second meeting stile 20A, 20B. Each extension 22A, 22B may respectively include brush seals 24A, 24B that engage a portion of the other extension 22A, 22B. These seals 24A, 24B, however, are not always capable of preventing elements, such as noise, weather, water, and insects, from breaching the seals. Moreover, if the panels 10A, 10B are slightly misaligned, one or both of the seals 24A, 24B may not properly engage the opposing interlocking extension 22A, 22B.

FIG. 1B illustrates the connection between a sill 38 of a frame 41 and a bottom rail 25 of a pair of panels 10A, 10B. Each bottom rail 25 includes a roller assembly 30 having a wheel 37 that is attached to the bottom rail 25 with an axle 40. The panels 10A, 10B slide relative to the frame 41 using the wheels 37 along a track 39 attached to the sill 38. However, gaps exists between the rollers 70 and the bottom rail 25 and between the wheels 37 and the track 39 since the wheels 37 only engage the track 39 at certain positions. As a result of these gaps, an effective seal is not provided between the frame 41 and the panels 10A, 10B.

Attempts have been made to address these issues by using various types of weather stripping between the panels and frame. For example, the weather stripping may be strip of felt, foam, or a pile of flexible synthetic material. In many instances, however, this weather stripping fails to act as a sufficient seal between the panels and frame. There is, therefore, a need for a sealing system that can be employed between a frame and panel or between adjacent panels that prevents the transfer from one side of the panel to the other side of the panel such environmental effects as noise, weather, water, heat/cold, and insects

Another issue prevalent associated with the seals between a frame and panel or between adjacent panels is that these seals can become disjoined. Either intentionally or unintentionally, the alignment between the frame and panel or between adjacent panels may be disturbed which can degrade the quality of the seal, since, in many instances, the integrity of the seal relies upon these members having certain positional relationships relative to one another. There is, therefore, also a need for a sealing system that maintains the positional relationships between the frame and panel or between adjacent panels.

Yet another issue associated with the movement of one or more panels relative to the frame is structural integrity and/or security of the panels relative to the frame. While in certain circumstances, allowing the panel to move relative to the frame is desirable, in other circumstances, not allowing the panel to move relative to the frame is desirable for the purpose of preventing undesired access through the panel. Means for providing these separate functionalities, however, can be incompatible with one another, and the means employed to provide both functions often involve tradeoffs that reduce the effectiveness of both functions. There is, therefore, also a need for a sealing system that provides structural integrity and/or security of the panels relative to the frame while allowing both the panel to move relative to the frame and also to selectively prevent movement of the panel relative to the frame.

### BRIEF SUMMARY OF THE INVENTION

Embodiments of the invention address deficiencies of the art with respect to effectively creating a seal between a panel and a frame or between two panels. In this regard, a combined sealing system for connecting a panel to a frame includes a first sealing system and a second sealing system. The first sealing system connects a first surface of the panel to a first surface of the frame, and the first sealing system has a first movable member movable along a first direction. The second sealing system connects a second surface of the panel to a second surface of the frame, and the second sealing system has a second movable member movable along a second direction. The combined sealing system has an unlocked configuration and a locked configuration. In the unlocked configuration, the panel is movable relative to the frame along a third direction. The first and second directions not parallel to the third direction.

In certain aspects of the combined sealing system, the first surface of the panel is substantially perpendicular to the second surface of the panel. Also, the first and second directions are substantially perpendicular to the third direction, and the first direction is substantially perpendicular to the second direction. The panel linearly slides relative to the frame.

In other aspects of the combined sealing system, engagement of the first sealing system causes engagement of the second sealing system. At least one or both of the first and second movable members are disposed within the frame. Also, at least one of the first and second movable members is a split anchor. In the locked configuration, the panel is connected to a second panel with a third sealing system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A and 1B are cross-sectional views, respectively of conventional connections between adjacent panels and between a panel and a frame;

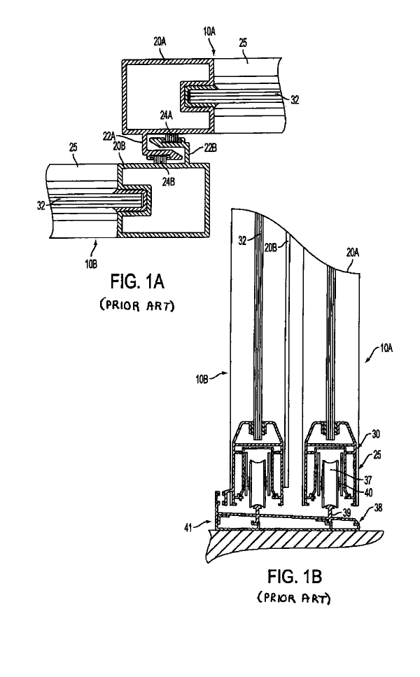

FIGS. 2A and 2B are side views, respectively, of a door/window system in a closed and partially opened position in accordance with the inventive arrangements;

FIGS. 3A-3C are partial perspective views, respectively, of a sealing system between a sill and a sill rail in unlocked, partially locked, and locked configurations in accordance with the inventive arrangements;

FIGS. 4A-4C are alternative partial perspective views, respectively, of FIGS. 3A-3C;

FIGS. 5A-5C are side views, respectively, of FIGS. 3A-3C while also showing the sill rail and panel;

FIGS. 6A-6C are cross-sectional, plan views, respectively, of a sealing system between a jamb and a stile rail in unlocked, partially locked, and locked configurations in accordance with the inventive arrangements;

FIGS. 7A-7C are partial perspective views, respectively, of a sealing system between a jamb and stile rail in unlocked, partially locked, and locked configurations in accordance with the inventive arrangements;

FIGS. 8A-8C are alternative perspective views, respectively, of FIGS. 7A-7C;

FIGS. 9A-9C are cross-sectional, side views, respectively, of a closing system for use with the sealing system in unlocked, partially locked, and locked configurations in accordance with the inventive arrangements;

FIGS. 10A-10C are partial perspective views, respectively, of a drive system for use with the sealing system in unlocked, partially locked, and locked configurations in accordance with the inventive arrangements;

FIGS. 11A-11C are cross-sectional, plan views, respectively, of a sealing system and closing system between meeting stiles of adjacent panels in unlocked, partially locked, and locked configuration in accordance with the inventive arrangements;

FIGS. 12A-12C are perspective views of FIGS. 11A-11C;

FIGS. 13A-13D are cross-sectional, plan views, respectively, of an alternative sealing and closing system between meeting stiles of adjacent panels in separated, unlocked, partially locked, and locked configuration in accordance with the inventive arrangements; and

FIGS. 14A-14C are perspective views of FIGS. 13A-13D.

### DETAILED DESCRIPTION OF THE INVENTION

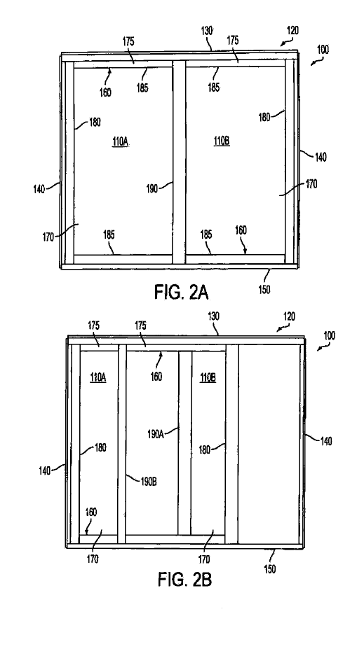

FIGS. 2A and 2B illustrate an exemplar door/window system 100 for use with the improved sealing system 200. The sealing system 200 can be used with many types of doors and/or windows, and the sealing system 200 is not limited to the particular door/window system 100 illustrated. For example, the sealing system 200 may be used with pocket doors, sliding doors, French doors, entry doors, garage doors, sliding windows, single-hung windows, double-hung windows, casement windows, and awning windows. The door/window system 100 includes panels 110A, 110B connected to a stationary frame 120.

The door/window system 100 is not limited in the manner in which the panel 110 moves relative to the frame 120. For example, the panels 110A, 110B may pivot relative to the frame 120. In certain aspects of the door/window system 100, however, either one or both of the panels 110A, 110B may move relative to the frame 120 along a plane parallel to a longitudinal axis of one of the surfaces (e.g., the header 130, jambs 140, or sill 150) of the frame 120, and/or along a plane substantially parallel to a longitudinal axis of an anchor 220 of the sealing system 200, and/or substantially along a plane defined by the panel 110A, 110B.

The frame 120 may include a header 130, jambs 140, and a sill 150. A header 130 is a structural member that spans an upper portion of the window/door opening. Jambs 140 are the outermost vertical side members of the frame 120. A sill 150 is a threshold or structural member that spans a lower-most portion of the window/door opening. As recognized by those skilled in the art, different terms may also be associated with the above-structure identified as the header 130, jambs 140, and sill 150.

Each panel 110 may include a sash 160 that surrounds a pane 170. The pane 170 is not limited as to a particular material. For example, the pane 170 may be translucent, such as glass or plastic, or opaque, such as with wood or metal. The sash may include a header rail 175, jamb or stile rails 180, and a sill rail 185. As recognized by those skilled in the art, different terms may also be associated with the structure identified as the header rail 175, the jamb or stile rail 180, sill rail 185, and meeting stile 190. The respective jamb/stile rails 180 of the panels 110A, 110B that adjoin one another when the door/window system 100 is closed are also known as meeting stiles 190A, 190B.

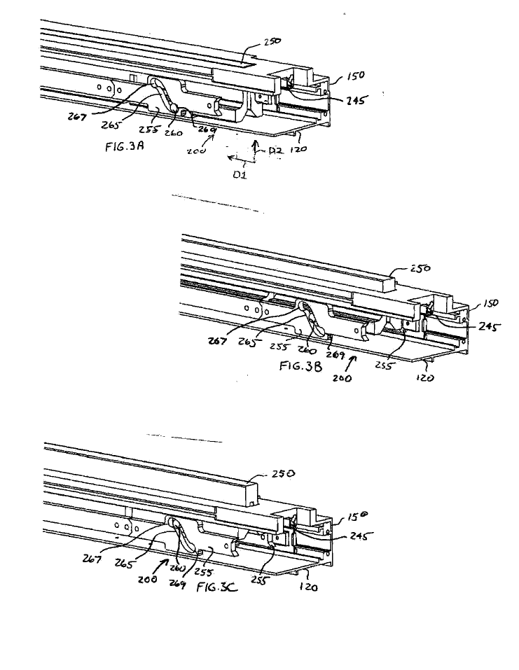

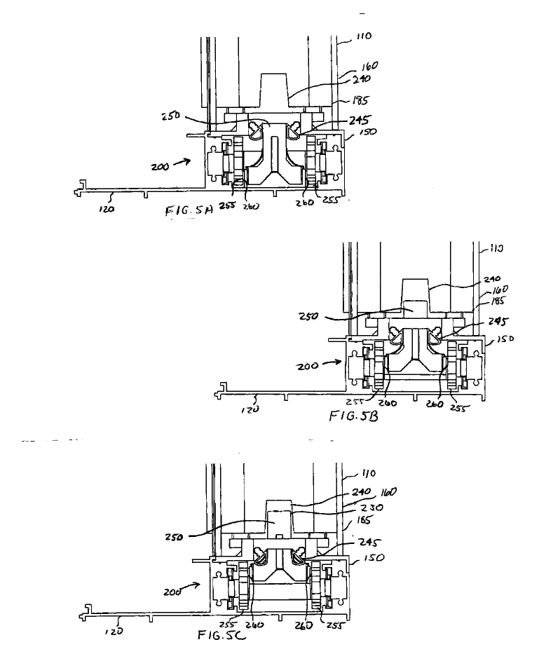

The sealing system 200 (see FIGS. 3A-3C, 4A-4C, 5A-5C, 6A-6C, 7A-7C, 12A-12D, 13A-13D) may be used with each of the members 175, 180, 185, 190 of the sash 160 to form a seal between each pair of adjacent surfaces of the sash 160 of the panel and the frame 120 or between adjacent surfaces of the meeting stile 190A of one panel 110A and the meeting stile 190B of another panel 110B. In this manner each of the separate sides of the panels 110A, 110B may employ the sealing system 200. As will be described in more detail below, not only does the sealing system 200 provide at least one seal between adjacent members of sash 160 and frame 120 or between adjacent meeting stiles 190A, 190B, each of the sealing systems 200 may prevent the movement of the panels 110A, 110B relative to the frame 120. In so doing, the sealing systems 200 can act as a lock and/or security device that prevents the forced opening of the panels 110A, 110B relative to the frame 120. Many types of sealing systems 200 so capable are known in the art, and the present door/window system 100 is not limited as to a particular type of sealing system 200.

To prevent the forced opening of the panels 110A, 110B, the sealing systems 200 are not limited as to a percentage of coverage between particular members of the frame 120 and/or panels 110A, 110B. For example, the sealing systems 200 may only cover a fractional number (e.g., 10%, 50%, 85%) of the length between particular members of the frame 120 and/or panels 110A, 110B. However, in certain aspects, the sealing systems 200 provide substantially complete coverage between the sash 160 of a panel 110A, 110B and the frame 120 or between the meeting stile 190A of one panel 110A and the meeting stile 190B of another panel 110B. In so doing, the combined sealing systems 200 can provide a seal substantially completely around one or both of the panels 110A, 110B.

Referring to FIGS. 3A-3C, 4A-4C and 5A-5C, a sealing system 200 for use in the door/window system 100 is illustrated. In certain aspects of the sealing system 200, the sealing system 200 employs the use of a movable anchor 250 to form a seal 230 between adjacent members of sash 160 and the frame 120. The seal 230 is formed by engagement of the movable anchor 250 of the sealing system 200 positioned on one of the frame 120 and sash 160 with another feature positioned on the other of the frame 120 and sash 160. However, in certain aspects of the sealing system 200, the movable anchor 250 is disposed in the frame 120 and engages a portion of the sash 160 of the panel 110.

The sealing system 200 is not limited as to the particular portion of the sash 160 with which the movable anchor 250 engages to form the seal 230. However, in certain aspects of the sealing system 200, the movable anchor 250 engages a surface of a first channel 240 within members (e.g., header rail 175, stile rail 180, and sill rail 185) of the sash 160.

By having the movable anchor 250 being positioned within the first channel 240, movement of the panel 110 relative to the frame 120 in a direction not parallel to the direction of the movement of the movable anchor 250 can be prevented. Moreover, in certain aspects, movement of the panel 110 relative to the frame 120 in a direction substantially perpendicular to the direction of movement of the movable anchor 250 can be prevented. In so doing, movement of the panel 110 relative to the frame 120 (via, for example, a forced entry) creates a force, against the movable anchor 250, having a minimal vector in the direction in which the movable anchor 250 moves. Thus, this forced movement of the panel 110 relative to the frame 120 has a reduced likelihood in forcing the movable anchor 250 to move thereby increasing the security of the door/window system 100.

The movable anchor 250 may directly engage a surface of the first channel 240. Alternatively the movable anchor 250 may include a seal (not shown) that engages a surface of the first channel 240 and/or engage a seal (not shown) within the first channel 240. The sealing system 200 may also includes seals 245 adjacent the movable anchor 250 to retard the movement of air, water, etc. and/or noise across the seals 245, and any seal so capable is acceptable for use in the sealing system 200. However, in certain aspects of the sealing system 200, the seals 245 are formed from a compressible material, such as foam.

Many types of devices are known as being capable of moving the movable anchor 250 to engage the panel 110, and the sealing system 200 is not limited as to a type of device so capable. However, in certain aspects of the sealing system 200, the movable anchor 250 is attached to one or more actuators 255. The actuator 255 linearly moves between a first position and a second position relative to the movable anchor 255, and movement of the actuator 255 from the first position to the second position causes the movable anchor 250 to move from a disengaged/unlocked position (e.g., FIGS. 3A, 4A, 5A) to an engaged/locked position (e.g., FIGS. 3C, 4C, 5C). Thus, the movement of the actuator 255 along an axis defined by direction D1 causes movement of the movable member along a different axis defined by direction D2.

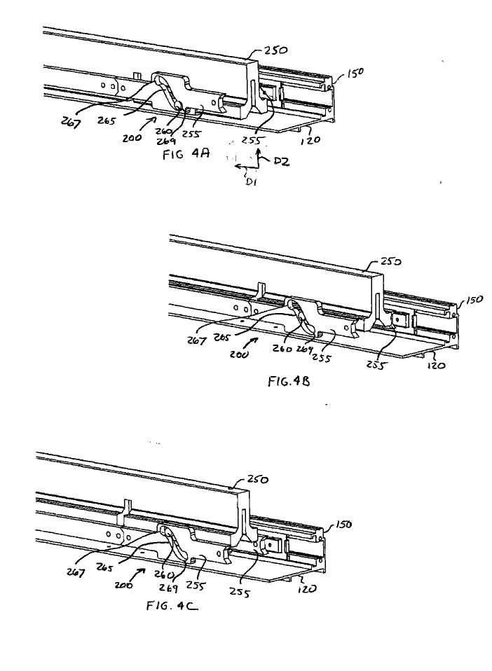

The actuator 255 includes an actuator slot 265 through which a pin 260 attached to the movable member extends. The actuator slot 265 has a first end 267 and a second end 269, and the actuator slot 265 may be configured such that the first end 267 is further along than the second end 269 in a first direction D1 defined by movement of the actuator 255 from the second position (e.g., FIGS. 3C, 4C) to the first position (e.g., FIGS. 3A, 4A). The first end 267 may also be further along than the second end 269 in a second direction D2 defined by movement of the anchor 250 from the engaged position (e.g., FIGS. 3C, 4C) to the disengaged position (e.g., FIGS. 3A, 4A).

The first and second ends 267, 269 may also include horizontal portions or dwells. Upon movable anchor 250 being engaged within the first channel 240 (i.e., the actuator 255 being in the second position), the pin 260 is positioned within the horizontal portion of the actuator slot 265. This positioning prevents the pin 260 (and also the movable anchor 250) from being unseated during, for example, a vertical shock load.

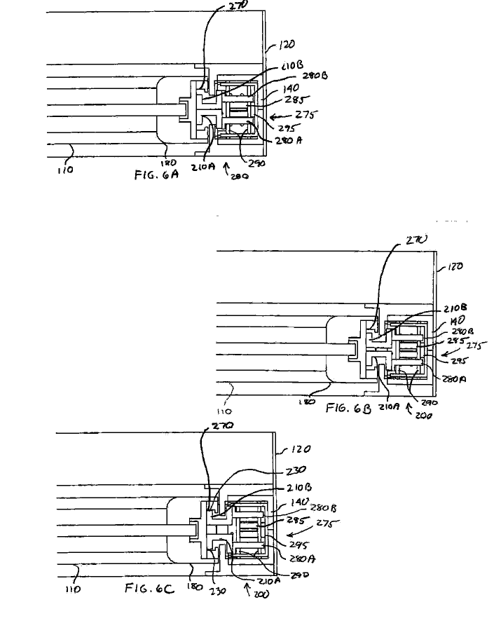

Additionally, as shown in FIG. 6C, a seal 230 may be formed by adjacent sealing systems 200 inter-engaging one another. In this manner, all the sealing systems 200 may be interconnected and completely or partially surround the panel 110. The door/window system is not limited as to a particular manner in which the sealing systems 200 inter-engage one another.

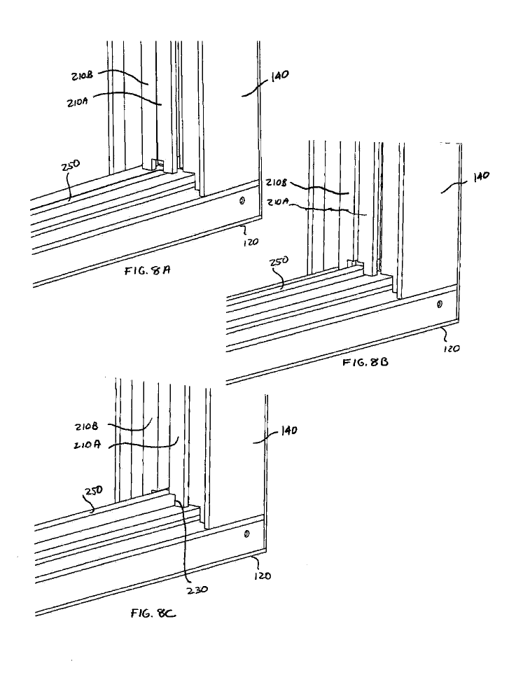

Referring to FIGS. 6A-6C, 7A-7C and 8A-8C, another sealing system 200 for use in the door/window system 100 is illustrated. In certain aspects of the sealing system 200, the sealing system 200 employs the use of a split anchor 210A, 210B to form a seal 230 between adjacent members of sash 160 and the frame 120. The seal 230 is formed by engagement of the split anchor 210A, 210B of the sealing system 200 positioned on one of the frame 120 and sash 160 with another feature positioned on the other of the frame 120 and sash 160. However, in certain aspects of the sealing system 200, the split anchor 210A, 210B is disposed in the frame 120 and engages a portion of the sash 160 of the panel 110.

The sealing system 200 is not limited as to the particular portion of the sash 160 with which the split anchor 210A, 210B engages to form the seal 230. However, in certain aspects of the sealing system 200, the split anchor 210A, 210B engages a surface of a second channel 270 within members (e.g., header rail 175, stile rail 180, and sill rail 185) of the sash 160.

By having the split anchor 210A, 210B being positioned within the second channel 270, movement of the panel 110 relative to the frame 120 in a direction not parallel to the direction of the movement of the movable anchor 250 can be prevented. Moreover, in certain aspects, movement of the panel 110 relative to the frame 120 in a direction substantially perpendicular to the direction of movement of the movable anchor 250 can be prevented. In so doing, movement of the panel 110 relative to the frame 120 (via, for example, a forced entry) creates a force, against the split anchor 210A, 210B, having a minimal vector in the direction in which the split anchor 210A, 210B moves. Thus, this forced movement of the panel 110 relative to the frame 120 has a reduced likelihood in forcing the split anchor 210A, 210B to move thereby increasing the security of the door/window system 100.

The split anchor 210A, 210B may directly engage one or more different surface of the second channel 270. Alternatively the split anchor 210A, 210B may include a seal (not shown) that engages a surface of the second channel 270 and/or engage a seal (not shown) within the second channel 270. These seals retard the movement of air, water, etc. and/or noise across the seals, and any seal so capable is acceptable for use in the sealing system 200.

Although not limited in this manner, the split anchor 210A, 210B each include L-shaped portions and the second channel 270 also includes L-shaped portions. By configuring the split anchor 210A, 210B and the second channel 270 in this manner, upon the sealing system 200 being in the unengaged position (i.e., FIG. 6A), the widest portions of the split anchor 210A, 210B are able to fit between the opening defined by the second channel 270. However, as the sealing system 200 is moved into the engaged position (i.e., FIG. 6C), the split anchor 210A, 210B moves by splitting apart, and the widest portions of the split anchor 210A, 210B are unable to fit between the opening defined by the second channel 270. In this manner, movement of the panel 110 relative to the frame 120 in a direction not parallel to the direction of the movable anchor 250 can be prevented.

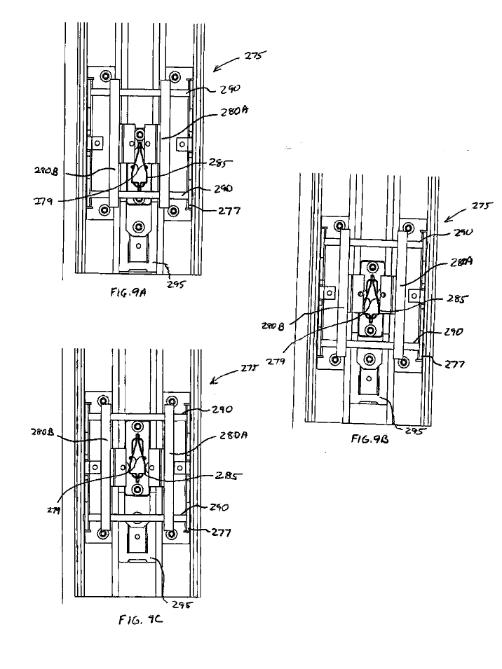

Many types of devices are known as being capable of splitting apart the split anchor 210A, 210B so as to engage the panel 110, and the sealing system 200 is not limited as to a type of device so capable. However, in further reference to FIGS. 9A-9C, a closing system 230 for use in splitting apart the split anchor 210A, 210B is illustrated.

The closing system 275 includes a first control members 280A, 280B and at least one second control member 285, and the at least one second control member 285 is disposed proximate to each of the first control members 280A, 280B. The first control members 280A, 280B are respectively connected to (or integral with) the split anchor 210A, 210B.

The closing system 275 moves the sealing system 200 from the unlocked configuration to the locked configuration upon the relative movement of the first control members 280A, 280B to the second control member 285 along a line substantially parallel to a longitudinal axis of one of the control members 280, 285. This movement generates a force against the first control members 280A, 280B, which causes the split anchors 210A, 210B to split apart.

The first and second control members 280, 285 may each include a step 279. Alternatively, only certain ones of the first and second control members 280, 285 may each include a step 279. Movement of the second control member 285 relative to first control members 280A, 280B to position the sealing system 200 in the locked configuration causes at least one surface of the second control member 285 to engage at least one surface of the first control members 280A, 280B, and any configuration of engaging surfaces between the first control members 280A, 280B and the second control member 285 is acceptable for use with the closing system 275.

For example, one of the steps 279 may include an inclined surface and the other of the steps 279 may include a roller. In certain aspects of the closing system 275, the second control member 285 includes a pair of angled steps 279, respectively facing each first control members 280A, 280B. As the first and second control members 280, 285 move relative to one another, the angled steps 279 of second control member 285 respectively engage the first control member 280 and causes a distance to increase between the first control members 280A, 280B.

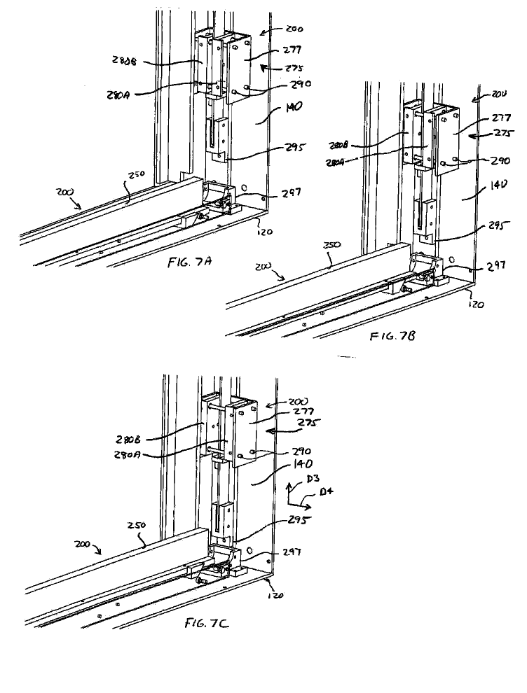

Although not limited in this manner, the first control members 280A, 280B are stationary along a first direction D3 and movable back and forth in a second direction D4 (see FIG. 7C). Also, the second control member 285 is disposed on a slide 295 that is movable back and forth along the first direction D3. As the slide 295 moves upward, the second control member 285 engages the first control member 280 and causes the sealing system 200 to engage.

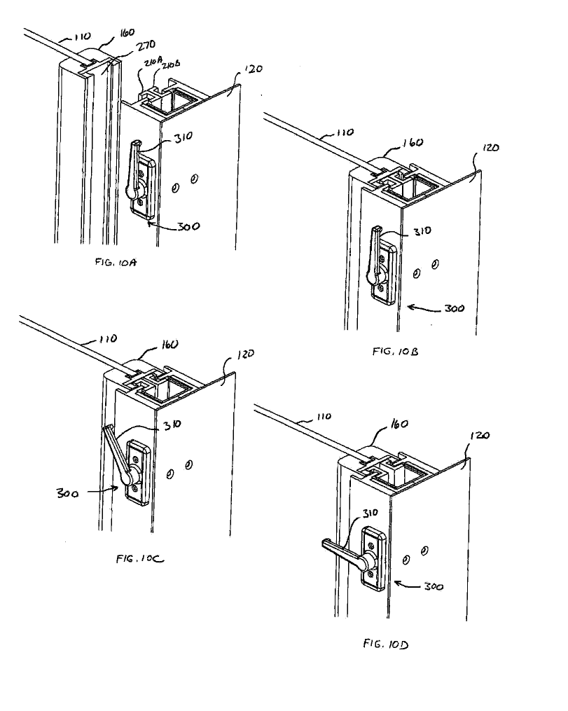

Referring to FIGS. 10A-10D, an exemplar drive system 300 for use in the door/window system 100 is illustrated. The drive system 300 moves the sealing system 200 from the unlocked configuration (e.g., FIGS. 3A, 4A, 5A, 6A, 7A, 8A, 9A, 10B) to a locked configuration (e.g., 3C, 4C, 5C, 6C, 7C, 8C, 9C, 10D). The drive system 300 may also move the sealing system 200 from the locked configuration to the unlocked configuration. In certain aspects of the door/window system 100, multiple drive systems 300 may be provided to separately close one sealing system 200.

However, in other aspects, the drive system 300 is configured to simultaneously move multiple and/or each of the separate sealing systems 200. For example, in certain aspects of the sealing systems 200, the motion used to generate the movement of the sealing systems 200 is a substantially linear motion along the longitudinal axis of each of the portions of the frame 120. Thus, a transfer system may be employed to transfer motion from the slide 295 to the actuator 255 and vice-versa. Many devices are capable of transferring linear motion along one axis and transferring the linear motion to another axis, and the door/window system 100 is not limited as to a particular device so capable. For example, the transfer device may include a set of inter-engaging gears. In certain aspects, the motion is transferred using a flexible strap (not shown) that is curved by a corner guide 297 (see FIGS. 7A-7C) at the intersection of the jamb 140 and the header/sill 130/150 and connects the slide 295 to the actuator 255.

How the drive system 300 moves the sealing system 200 from the unlocked configuration to the locked configuration (and back again) is not limited as to a particular manner and/or device. As can be readily envisioned, the configuration and operation of the drive system 300 may be determined by the configuration and operation of the sealing systems 200. Although the illustrated drive system 300 is shown as being driven with a manual device, other devices capable of driving a sealing system 200 are commonly known, such as a magnetic, mechanical, and electro-mechanical devices.

As previously described, the present sealing system 200, in operation, employs the back and forth motion of the actuator 255 and/or a slide 295. Any drive system 300 capable of moving the actuator 255 and/or slide 295 in this manner is acceptable for use with the present door/window system 100. In a present aspect of the door/window system 100, the drive system 300 employs uses a rotating handle 310 that is attached, either directly or indirectly to the slide 295. As the handle 310 rotates, the slide 295 moves in a certain direction. Many types of devices are capable of translating rotational motion into linear motion and any device so capable is acceptable for use with the door/window system 100. For example, a rack and pinion system (not shown) is a common system used to translate rotational motion into linear motion.

The closing system 300 is not limited as to the particular manner in which the sealing system 200 is positioned from the locked position to the unlocked position. For example, upon the first and second control members 280, 285 moving relative to one another in a direction opposite to the direction that causes a distance to increase between the second control member 285 and the first control members 280A, 280B, a resilient member (or other device) may bias the first control members 280A, 280B towards the second control member 285.

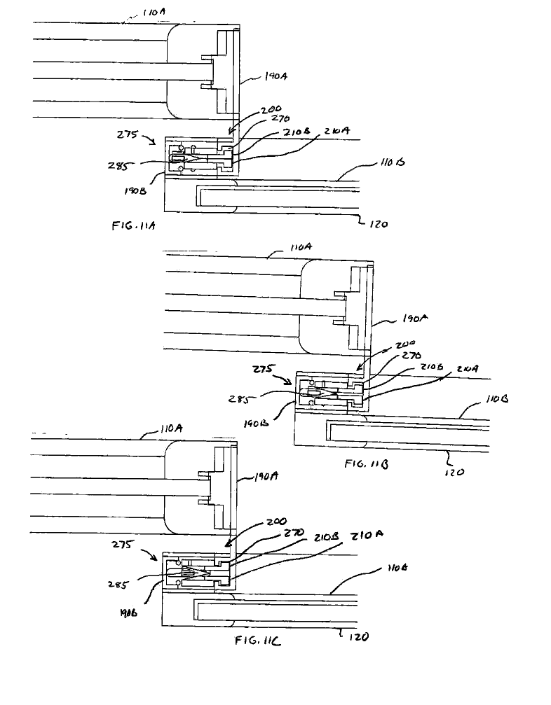

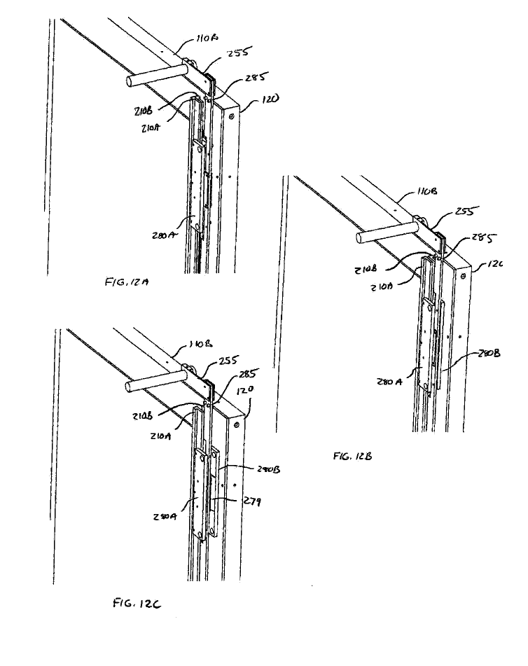

Referring to FIGS. 11A-11C and 12A-12C, an additional sealing system 200 and closing system 275 for use in the door/window system 100 are illustrated, respectively in an unlocked configuration, a partially locked configuration, and in a locked configuration. The sealing system 200 connects meeting stiles 190A, 190B of the panels 110A, 110B, although the sealing system 200 is not limited in this manner and can be used between other features in the door/window system 100. As illustrated, the sealing system 200 may be nearly identical in configuration to the sealing system 200 illustrated in FIGS. 6A-6C.

Although not limited in this manner, the closing system 275 includes a second control member 285 that slides between a pair of opposing first control members 280A, 280B, which are respectively attached to the split anchor 210A, 210B. The second control member 285 may be attached to the actuator 255, and as the actuator 255 moves back and forth, the second control member 285 wedges between the first control members 280A, 280B so as to control the opening of the split anchor 210A, 210B.

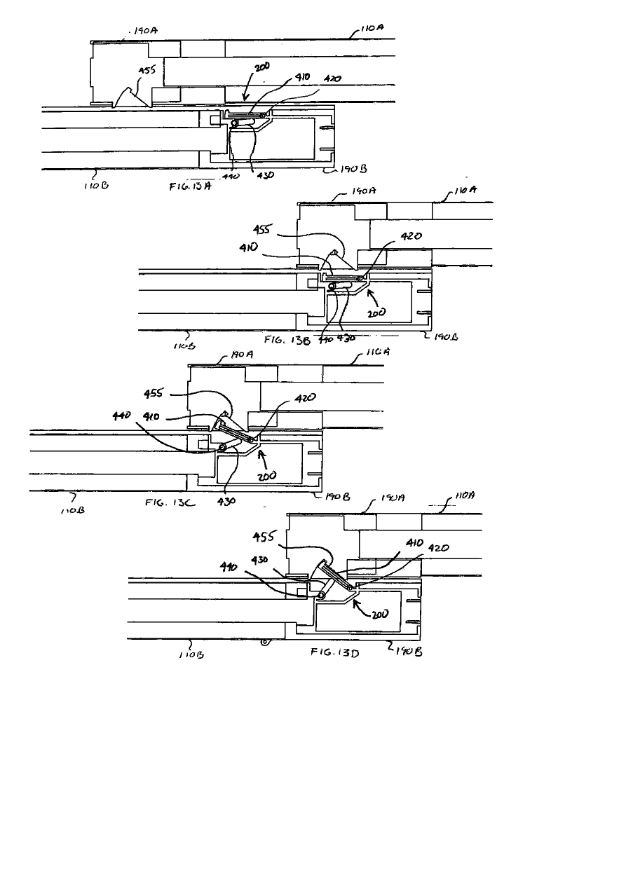

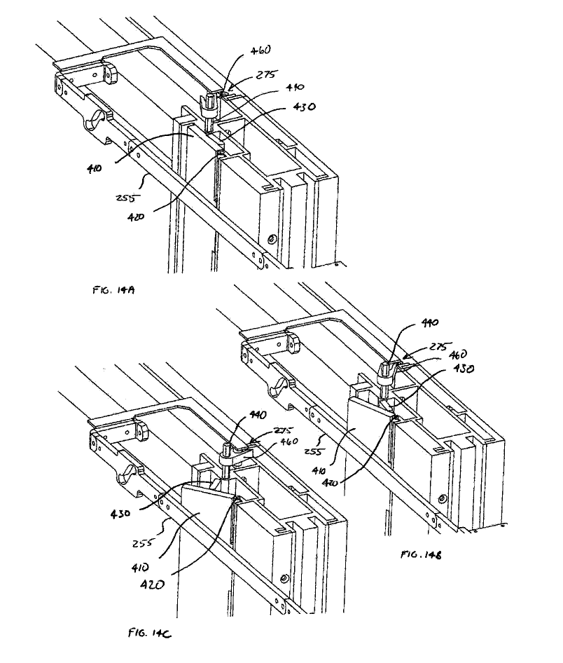

Referring to FIGS. 13A-13D and 14A-14C, yet another sealing system 200 for use in the door/window system 100 is illustrated, respectively in a separated configuration, an unlocked configuration, a partially locked configuration, and in a locked configuration. The sealing system 200 connects meeting stiles 190A, 190B of the panels 110A, 110B, although the sealing system 200 is not limited in this manner and can be used between other features in the door/window system 100.

The sealing system 200 operates by using a drive gate 430, which urges a seal gate 410 against an opposing face 455 to form a seal between the meeting stiles 190A, 190B. The seal gate 410 and/or opposing face 455 may include seals (not shown) on one or both surfaces, and this seal can be any type of seal capable of acting to retard the movement of air, water, etc. and/or noise across the interface between the opposing face 455 and the seal gate 410.

The sealing system 200 is not limited in the manner by which the gate seal gate 410 engages the opposing face 455. For example, the seal gate 410 may operate as a linearly-traveling piston. However, in certain aspects of the sealing system 200, the seal gate 410 pivots about a seal pivot 420. The manner in which the seal gate 410 itself is driven in not limited. For example, the seal gate 410 may be directly driven, for example, at the seal pivot 420. Alternatively, in certain aspects of the active seal, the seal gate 410 is driven using a drive gate 430 that causes the seal gate 410 to rotate about the seal pivot 420.

Although not limited in this manner, the drive gate 430 pivots about a drive pivot 440 and is itself driven by a closing system 275. Any closing system 275 capable of driving the drive gate 430 is acceptable for us in the door/window system 100. However, in certain aspects, the closing system 275 is directly or indirectly driven by the actuator 255, which is rotatably attached to a lever 460, which is itself attached to the drive pivot 440. In so doing, the back and forth motion of the actuator 255 is translated into rotational motion at the drive pivot 440, thereby driving the rotating of the drive gate 430. By using leverage generated by the inter-engaging levers 410, 430, the sealing system 200 is capable of exerting significant force against the meeting stiles 190A, 190B, and in so doing, functions to create a seal between the meeting stiles 190A, 190B.

What is claimed is:

1. A combined sealing system for connecting a panel to a frame, comprising:
a first sealing system for connecting a first surface of the panel to a first surface of the frame, the first sealing system having a first movable member movable along a first direction; and
a second sealing system for connecting a second surface of the panel to a second surface of the frame, the second sealing system having a second movable member movable along a second direction, wherein
the combined sealing system having an unlocked configuration and a locked configuration,
in the unlocked configuration, the panel movable relative to the frame along a third direction, and
the first and second directions not parallel to the third direction.

2. The combined sealing system of claim 1, wherein the first surface of the panel is substantially perpendicular to the second surface of the panel.

3. The combined sealing system of claim 1, wherein the first and second directions are substantially perpendicular to the third direction.

4. The combined sealing system of claim 1, wherein engagement of the first sealing system causes engagement of the second sealing system.

5. The combined sealing system of claim 1, wherein the panel linearly slides relative to the frame.

6. The combined sealing system of claim 1, wherein at least one of the first and second movable members is disposed within the frame.

7. The combined sealing system of claim 4, both of the first and second movable members are disposed within the frame.

8. The combined sealing system of claim 1, wherein at least one of the first and second movable members is a split anchor.

9. The combined sealing system of claim 1, wherein the first direction is substantially perpendicular to the second direction.

10. The combined sealing system of claim 1, further comprising a third sealing system, and in the locked configuration, the panel is connected to a second panel with the third sealing system.

11. A combined sealing system for connecting a first panel to a frame and a second panel, the first panel linearly sliding relative to the frame and the second panel, comprising:
a first sealing system for connecting a first surface of the first panel to a first surface of the frame, the first sealing system positioned within the frame and having a first movable member movable along a first direction towards the first panel; and
a second sealing system for connecting a second surface of the first panel to a second surface of the frame, the second sealing system positioned within the frame and having a second movable member movable along a second direction substantially perpendicular to a plane defined by the first panel, wherein
the combined sealing system having an unlocked configuration and a locked configuration.

12. The combined sealing system of claim 11, wherein the first surface of the panel is substantially perpendicular to the second surface of the panel.

13. The combined sealing system of claim 11, further comprising a third sealing system for connecting a third surface of the first panel to a surface of the second panel.

14. The combined sealing system of claim 13, wherein engagement of the second sealing system causes engagement of the first sealing system and the third sealing system.

15. The combined sealing system of claim 11, wherein engagement of the second sealing system causes engagement of the first sealing system.

16. The combined sealing system of claim 11, wherein the second movable member is a split anchor.
